(19) United States
(12) Patent Application Publication
(10) Pub. No.: US 2007/0168975 A1
(43) Pub. Date: Jul. 19, 2007

(54) Debugger and test tool

(76) Inventor: Thomas Kessler, St. Leon-Rot (DE)

Correspondence Address: FISH & RICHARDSON, P.C., PO BOX 1022, MINNEAPOLIS, MN, 55440-1022, US

(21) Appl. No.: 11/300,018

(22) Filed: Dec. 13, 2005

(51) Int. Cl. G06F 9/44

(52) U.S. Cl. 717/124

(57) ABSTRACT

Systems and techniques for debugging machine-readable instructions are described. In one implementation, a method includes receiving an identification of a debugger, identifying an activated business software module that is to be debugged, receiving a change to the instructions of the business software module, establishing a second version of the business software module that includes the change, and activating the second version for the debugger while the business software module remains activated. The business software module is an individually functional set of machine-readable instructions operable to integrate and manage operations of a business.

### TECHNICAL FIELD

This disclosure relates to debugging and testing of machine-readable instructions that are operable to cause one or more machines to perform various functions.

### BACKGROUND

Debugging is the process of detecting, locating, and/or correcting errors in machine-readable instructions. The errors can be, e.g., logical or syntactical. Debugging can include testing the machine-readable instructions to determine if data processing activities performed in accordance with the instructions conform with expectations.

### SUMMARY

Systems and techniques for debugging machine-readable instructions are described. In one aspect, a method includes receiving an identification of a debugger, identifying a portion of a set of activated machine-readable instructions that is to be tested, establishing a second version of the portion of the set of machine-readable instructions, and activating the second version for the debugger while the portion of the set remains activated.

This and other aspects can include one or more of the following features. The second version can be established by copying the portion of the set of machine-readable instructions. The second version can be established by receiving a change to the portion of the set of machine-readable instructions and including the change in the second version.

The portion of the set of machine-readable instructions can be an independently functional module, such as a globally activated, independently functional module. Services can be provided to the debugger using the activated second version. The portion of the set of machine-readable instructions can be replaced with the second version. For example, the portion of the set of machine-readable instructions can be replaced by globally activating the second version in a distributed data processing system landscape.

In another aspect, a method includes receiving an identification of a debugger, identifying an activated business software module that is to be debugged, receiving a change to the instructions of the business software module, establishing a second version of the business software module that includes the change, and activating the second version for the debugger while the business software module remains activated. The business software module can include an individually functional set of machine-readable instructions operable to integrate and manage operations of a business.

This and other aspects can include one or more of the following features. The change can be received by outputting the instructions of the business software module to the debugger, checking syntax of the change to the instructions, and notifying the debugger if the syntax is unacceptable.

In another aspect, an article includes a machine-readable medium storing instructions operable to cause one or more machines to perform operations. The operations include outputting a set of activated machine-readable instructions to a user, receiving a change to the activated machine-readable instructions from the user, and implementing the change in the activated machine-readable instructions without deactivating the activated machine-readable instructions. The activated instructions are available to the runtime environment of a data processing system.

This and other aspects can include one or more of the following features. The operations can also include checking syntax of the change to the activated machine-readable instructions, and notifying the user if the syntax is unacceptable. The set of activated machine-readable instructions can be output as a display of the text of activated source code to the user. The activated machine-readable instructions can be a locally activated set of activated machine-readable instructions such as, e.g., a business software module. The change in the activated machine-readable instructions can be activated by providing services to a client in a distributed data processing landscape. The change can be implemented by providing services to the user in a distributed data processing system landscape.

The details of one or more implementations are set forth in the accompanying drawings and the description below. Other features and advantages will be apparent from the description and drawings, and from the claims.

### DESCRIPTION OF DRAWINGS

FIG. 1 is a schematic representation of a system landscape.

FIG. 2 is a schematic representation of one implementation of the system landscape of FIG. 1.

FIG. 3 is a flowchart of a process for testing machine-readable instructions.

FIGS. 4 and 5 show the establishment of locally activated modules at servers in the system landscapes of FIGS. 1 and 2.

FIG. 6 illustrates the exchange of information between globally activated modules in a system landscape.

FIG. 7 illustrates the exchange of information between locally activated modules in a system landscape.

FIG. 8 is a flowchart of a process in which the instructions in an activated module or function can be changed for debugging.

FIG. 9 shows an example of a user interface for entering changes during debugging.

Like reference symbols in the various drawings indicate like elements.

### DETAILED DESCRIPTION

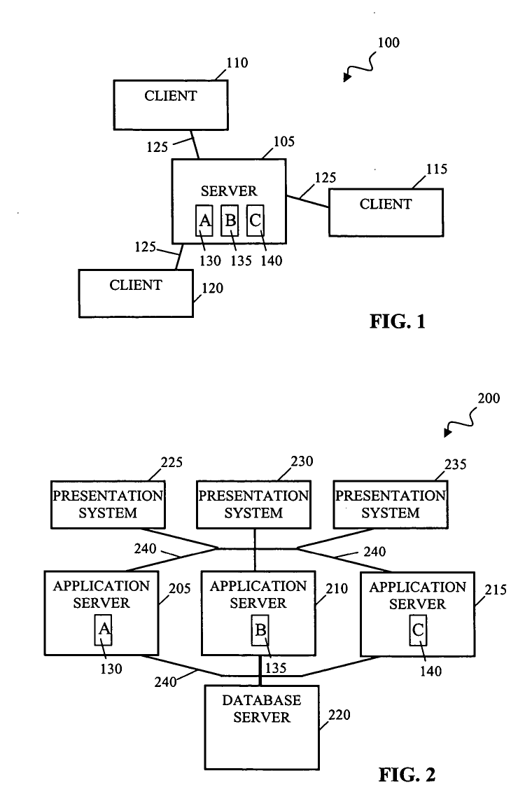

FIG. 1 is a schematic representation of a distributed data processing system landscape 100. A distributed data processing system landscape can include a collection of data processing devices, software, and/or systems (hereinafter “data processing systems”) that operate autonomously yet coordinate their operations across data communication links in a network. By operating autonomously, the data processing systems can operate in parallel, handling local workloads of data processing activities. The data communication link allows information regarding the activities, including the results of performance of the activities, to be exchanged between data processing systems. To these ends, many distributed data processing systems include distributed databases and system-wide rules for the exchange of data.

System landscape 100 thus is a collection of data processing systems that exchange information for the performance of one or more data processing activities in accordance with the logic of a set of machine readable instructions. System landscape 100 includes one or more servers 105 that are in communication with a collection of clients 110, 115, 120 over a collection of data links 125.

Server 105 is a data processing system that provides services to clients 110, 115, 120. The services can include, e.g., the provision of data, the provision of instructions for processing data, and/or the results of data processing activities. The services can be provided in response to requests from clients 110, 115, 120.

The services can be provided by server 105 in accordance with the logic of a one or more of modules 130, 135, 140. A module is an individually functional subset of a set of instructions. Each module is generally allocated to the performance of one or more subsets of the data processing activities performed by a set of instructions. For example, when a set of instructions is enterprise software that is operable to integrate and manage the operations of a company or other enterprise, individual modules can be allocated to managing product lifecycles, managing customer relationships, managing supply chains, managing master data, managing financial activities, and the like. Modules can exchange information using predefined protocols.

Clients 110, 115, 120 are data processing systems that receive services from server 105. Clients 110, 115, 120 can be responsible for other data processing activities, such as managing interaction with human users at their respective locations. Clients 110, 115, 120 can generate requests for such services and convey the requests to server 105 over one or more of data links 125.

Data links 125 can form a data communication network such as a LAN, a WAN, or the Internet. System landscape 100 can also include additional data links, including direct links between clients 110, 115, 120 and data links to systems and devices outside landscape 100, such as a communications gateway (not shown).

The roles of “server” and “client” can be played by the same individual data processing systems in system landscape 100. For example, the data processing system denoted as server 105 may receive certain services from one of clients 110, 115, 120. Thus, a data processing system may be a “server” in the context of a first set of services but a “client” in the context of a second set of services.

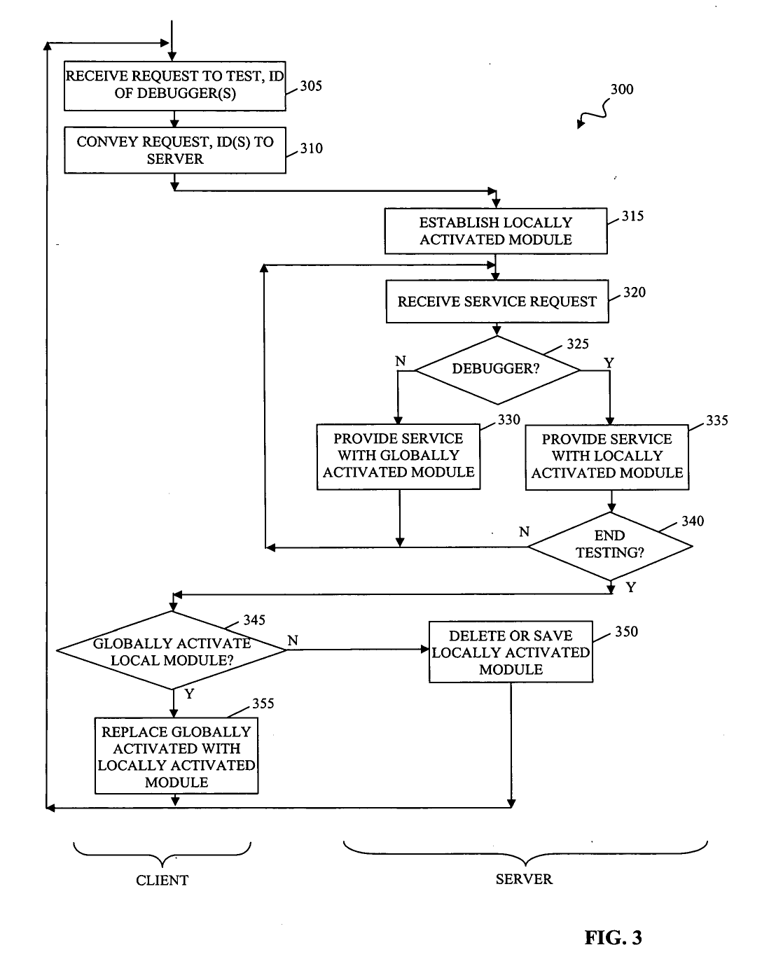

FIG. 2 is a schematic representation of another implementation of a system landscape, namely, a system landscape 200. System landscape 200 is a three tiered hierarchy of data processing systems and includes application servers 205, 210, 215 and one or more database servers 220. Application servers 205, 210, 215 and database server 220 are in data communication with each other and with a collection of presentation systems 225, 230, 235 over a collection of data links 240.

Application servers 205, 210, 215 are data processing systems that provide services to presentation systems 225, 230, 235 and/or database server 210. Each application server 205, 210, 215 can provide services in accordance with the logic of one or more software modules 130, 135, 140. For example, application server 205 can provide services in accordance with the logic of software module 130, application server 210 can provide services in accordance with the logic of software module 135, and application server 215 can provide services in accordance with the logic of software module 140, as shown. However, individual application servers can also provide services in accordance with the logic of multiple software modules, and services in accordance with the logic of a single software module can be provided by multiple application servers (not shown).

Database server 220 is a data processing system that provides storage, organization, retrieval, and presentation of instructions and data services to application servers 205, 210, 215 and/or presentation systems 225, 230, 235.

Presentation systems 225, 230, 235 are data processing systems that receive services from application servers 205, 210, 215 and database server 220. Presentation systems 225, 230, 235 can also manage interaction with human users at their respective locations, such as the display of information on a graphical user interface. Presentation systems 225, 230, 235 can generate requests for services and convey the requests to application servers 205, 210, 215 and database server 220 over one or more of data links 240.

In system landscapes such as landscapes 100, 200, one or more users may seek to debug the machine-readable instructions that form the basis of data processing activities. The instructions can form the basis of data processing activities at remote systems. For example, a user can seek to debug instructions that form the basis of data processing activities at an application server 215 by interacting with a presentation system 225. The debugged instructions can be in a form with which the user can interact. For example, the machine-readable instructions can be encoded as source code in a high level programming language such as Advanced Business Application Programming (ABAP).

FIG. 3 shows a process 300 for testing machine-readable instructions that form the basis of data processing activities in system landscapes such as landscapes 100, 200. Process 300 can be performed when one or more users interacts with one or more systems to test a set of machine-readable instructions used by one or more servers to provide services. The set of machine-readable instructions can be, e.g., a module or a function. The tested module or function can perform operations that have the same functionality as an existing, globally activated module or function. For example, the tested module or function can nearly be a copy of a globally activated module or function that includes one or more changes, such as those received from a debugger. In the context of system landscapes 100, 200 (FIGS. 1 and 2), process 300 can be performed with users at one or more clients 110, 115, 120 or one or more presentation systems 225, 230, 235 to test one or more modules 130, 135, 140 used by one or more servers 105, 205, 210, 215 to provide services.

In process 300, a client system can receive a request to commence testing activities, along with an identification of one or more debuggers, at 305. A debugger is a system, an individual, or a group of individuals who contribute to debugging activities, including the testing of a module or function. The request can identify a set of machine-readable instructions for testing. For example, the request can identify a computer program for testing, a module for testing, or the request can identify a function for testing. A function is a component of a module. A function can correspond to a self-contained set of data processing activities in a module and can be used in one or more processes in a module. The module or function can be activated in that it is made available to the runtime environment, e.g., to provide services to clients. The request can identify one or more debuggers by system, by name, by role, by location, or by other identifying characteristic. The client system can be, e.g., one of clients 110, 115, 120 (FIG. 1) and presentation systems 225, 230, 234 (FIG. 2).

The request can be received in a number of different ways. For example, an affirmative indication that testing and/or debugging is to commence can be received from a debugger. Such an affirmative indication can be a system command (such as “command /h” in the R/3 system, SAP AG (Walldorf, Germany)) received from a debugger. As another example, in many ABAP processing systems, a debugger can insert a request to commence testing at a location in the machine-readable instructions. Such a request is generally referred to as a “break-point.” When the instructions are being used to perform operations for a debugger, the process flow of operations is stopped when a break-point is reached. The operations can then enter a test (and/or a debugging) mode. A break-point can have a lifespan during which the flow of operations is stopped for testing and/or debugging. After the end of such a lifespan, the break-point can be ignored and the flow of operations can continue. The lifespan can be denoted in hours, number of operations, or other units.

The client system can convey the request, along with identifications of the one or more debuggers, to a server system at 310. The information can be directed to a specific server or the information can be broadcast throughout a system landscape. The server can be, e.g., one of server 105 (FIG. 1) and servers 205, 210, 215 (FIG. 2). The information can be conveyed over a data link, such as links 125, 240.

The server can establish a locally activated module (or function) at 315. As used herein, a locally activated module or function is a module or function that is activated for a specified subset of data processing systems and/or users in a system landscape. For example, a locally activated module or function may provide services only to the identified debuggers. The activation of a set of machine readable instructions makes the set of instructions available to the runtime environment. A set of machine readable instructions can be activated by creating an activated version of the set of instructions from an inactivated version of the set. The activation process can also include a check for syntax errors before the creation of the activated version of the set and the marking of the set of instructions as activated. For example, an entry for an object that includes a set of activated instructions can be deleted from a list of inactivated objects or an entry for an object that includes a set of activated instructions can be added to a list of activated objects. The locally activated module or function can be activated for one or more debuggers specified by the request received from the client system.

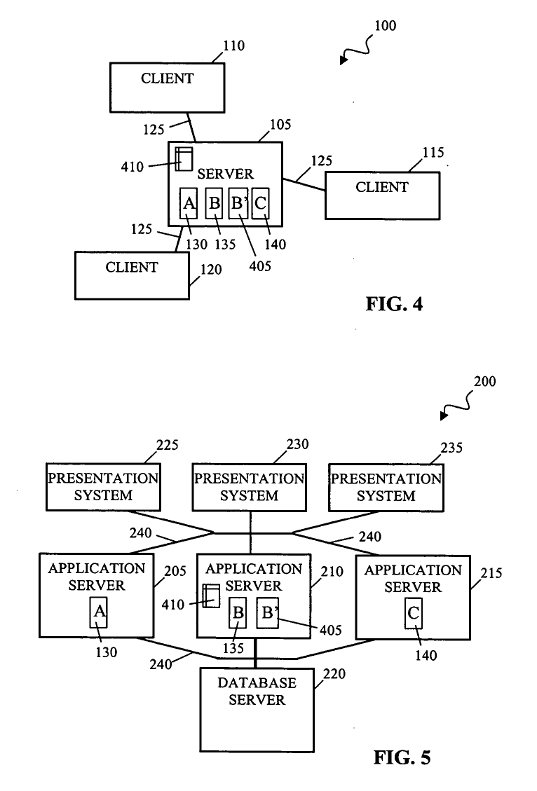

FIGS. 4 and 5 show the establishment of locally activated modules 405 at servers 105, 210 in system landscapes 100, 200. Modules 405 are initially duplicates of modules 135 but can change if changes are made during debugging or other activities. Servers 105, 210 can also establish a list or other record 410 that identify debuggers for whom locally activated modules 405 are activated.

Returning to FIG. 3, the server that has established a locally activated module or function can receive a service request at 320. The server can determine if the service is to be provided to one of the debuggers for which activation was specified at 325. In the context of system landscapes 100, 200 in FIGS. 4 and 5, the server can compare the identity of a service requester to a list of specified debuggers in record 410.

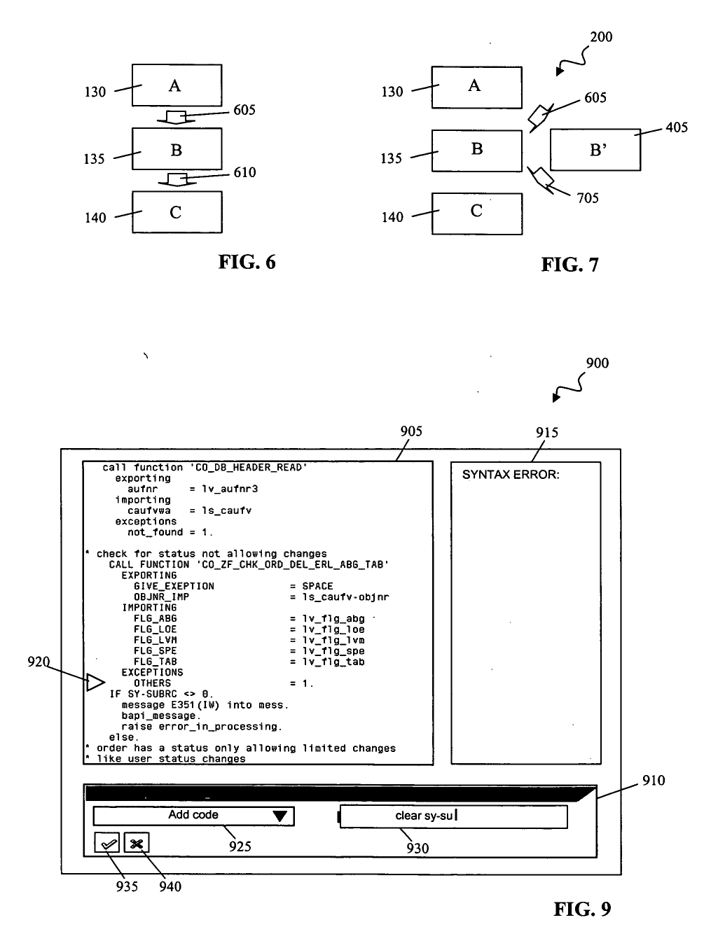

If the service is to be provided to a system or individual who is not specified as a debugger, the server can provide services using the globally activated module or function at 330. FIG. 6 illustrates the provision of such services in the context of the exchange of information 605, 610 between operations performed in accordance with the logic of globally activated modules 130, 135, 140 in a system landscape.

Returning to FIG. 3, if the server determines that the request is to be provided to one of the specified debuggers, the system can provide services with the locally activated module or function at 335. FIG. 7 illustrates the provision of such services in the context of the exchange of information 605, 710 between operations performed in accordance with the logic of modules 130, 405, 140 in a system landscape. In particular, information 605 is directed from globally activated module 130 to locally activated module 405, bypassing globally activated module 135. Although globally activated module 135 remains activated to provide services for the remainder of the system landscape, locally activated module 405 is used to perform operations for the specified debuggers.

Depending on the state of debugging, the operations performed using locally activated module 405 may differ from the operations which would be performed on the same information by globally activated module 135. Thus, information 705 can differ from the information 610 that would have resulted had the operations been performed in accordance with the logic of globally activated module 135.

Returning to FIG. 3, the server can also determine if testing of the locally activated module or function is to end at 340. For example, the server can receive, from one or more debuggers, an affirmative indication that testing is to end. The affirmative indication can be a response to a prompt, such as the display of an “end test” button or other indicator on a user interface. The indication can be received by the server, e.g., over a system such as one of clients 110, 115, 120 or presentation systems 225, 230, 235. If the server determines that testing of the locally activated module or function is not to end (e.g., by failing to receive such an affirmative indication that testing is to end), the server can receive additional service requests at 320.

If the server determines that testing is to end, process 300 can return to the client where a determination whether the locally activated module or function is to be globally activated is made at 345. The client can make this determination by, e.g., receiving instructions regarding global activation from one or more debuggers. The instructions can be received in response to a query by the server or the instructions can be received as an unprompted global activation request by one or more debuggers. The determination can also include a confirmation and/or certification step, such as a query sent to a system manager or other third party to confirm that global activation of the former locally activated module or function is permitted.

If the locally activated module or function is not to be globally activated, the server can delete or save the locally activated module or function at 350. The deletion or save can be in response to instructions received from a debugger at a client. If the locally activated module or function is to be globally activated, the locally activated module or function can be globally activated at 355. Global activation can include the debugger providing activation instructions to the client regarding how the previously locally activated module is to be globally activated. The server can convey such instructions to the server for implementation. In the context of system landscapes 100, 200, in FIGS. 4 and 5, global activation of module 405 results in the provision of services to all users and systems in accordance with the logic of module 405.

Note that changes to the instructions in a locally activated module or function can be received at a number of different points in the process flow of process 300. For example, the request to debug can include changes to the instructions that form the basis of operations. Such changes can be made during the establishment of a locally activated module or function at 315. As another example, the locally activated module or function, once established, can be deactivated and changes to the instructions can be made in the inactivated version. Once such changes are made, the inactivated version can be locally activated and services provided to debuggers in accordance with the logic of the locally activated version at 335.

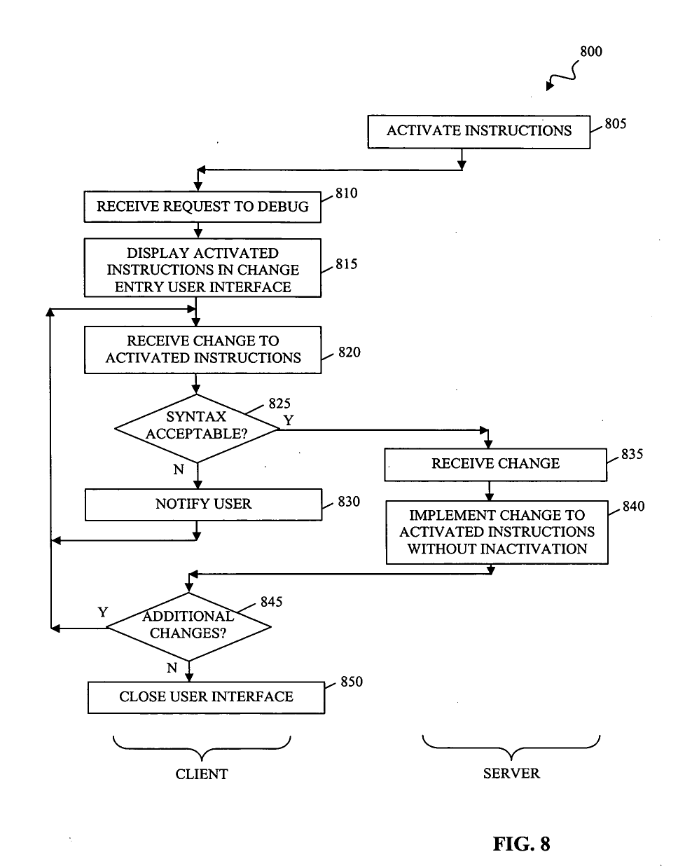

FIG. 8 shows a process 800 in which the instructions in an activated module or function can be changed while the module or function remains activated. Process 800 can thus be used in debugging activated instructions. The module or function changed in process 800 can be locally or globally activated. For example, process 800 can be performed between the establishment of a locally activated module or function at 315 and the receipt of a service request at 320 in process 300 (FIG. 3).

With a module or function activated at a server at 805, a client can receive a request to debug the activated module or function at 810. The client can retrieve the appropriate instructions of the activated module or function from the server that provides services with the activated module or function and display the instructions in a change entry user interface at 815.

The client can receive changes to the activated instructions at 820. For example, the user changes may indicate that certain text is to be added to or deleted from a location in the activated instructions. In such a case, the client could receive an identification of the location where the change is to be made, as well as the change itself. The client can also check the syntax of the received change to the activated instructions to determine if it is acceptable at 825. Syntax checking can include, e.g., type checks, scoping rule enforcement, as well as other semantic analyses such as static binding, instantiation of templates, and optimization. The syntax check can be performed batchwise, i.e., as batches of changes are received. For example, the syntax of an entire line of instructions that is to be added to the activated instructions can be checked.

If the client determines that there is a syntax error in the received change, the client can notify the user of the error at 830 and return to receive additional changes to the activated instructions at 820. On the other hand, if the client determines that the syntax in the received change is acceptable, the client can convey the change to the server where it is received at 835. The server can implement the change to the activated instructions without inactivating the instructions at 840. The implementation of the change can include providing one or more services with the changed instructions. Since the changed instructions can be locally activated, such services can be provided to a specified subset of systems and/or users in a system landscape (such as the debuggers in process 300, FIG. 3). In some implementations, the server or the client can also perform a syntax check for a larger portion of the instructions in the activated module or function to ensure that the syntax of the change is appropriate in the context of the larger portion, and then notify the user of any unacceptable syntax.

With the changes implemented at the server, the client can determine if additional changes are desired at 845. For example, the client can receive input over a change entry user interface indicating whether additional changes are desired. As another example, the lack of input over a change entry user interface can be taken as an indication that additional changes are not desired.

If it is determined that additional changes are desired, process 800 can return to 820 to receive an additional change to the activated instructions. If it is determined that additional changes are not desired, the client can close the change entry user interface at 850 and allow the change to remain in the activated instructions.

FIG. 9 shows an example change entry user interface 900. Change entry user interface 900 includes an instruction display 905, an instruction change input 910, and a syntax error notification output 915.

Instruction display 905 can render the machine-readable instructions in a module or function in a format that can be interpretted by a human user. For example, the text of source code of a module or function can be displayed in instruction display 905. Instruction display 905 can include an active marker 920 that a user can move to indicate a location in the machine-readable instructions where changes are to be made.

Instruction change input 910 includes a change category input 925, a change input 930, a change accept input 935, and a change decline input 940. Change category input 925 is an input that receives the category of a change from a user. Example categories of changes include adding instructions, deleting instructions, and modifying instructions.

Change input 930 is an input that can receive a change to machine-readable instructions from a user. For example, change input 930 can receive the text of a change to the source code of instructions from a user. Change accept input 935 is an input that can receive a user's acceptance of a change entered in change input 930. Change decline input 940 is an input that can receive a user's rejection of a change entered in change input 930.

Syntax error notification output 915 is an output that can provide information regarding a syntax error present in an accepted change entered in change input 930. For example, syntax error notification output 915 can display a textural description of a syntax error in the text of a change to source code entered in change input 930 and accepted with an acceptance input to change input 930.

In operation, change entry user interface 900 can be rendered for a user. The text the source code of activated instructions can be displayed in instruction display 905. A user can select a particular location in the activated instructions for change using active marker 920 and a category of the change using change category input 925. The user can also input the actual change itself using change input 930, which then can be accepted or declined by the user using change accept input 935 or a change decline input 940.

If the change in change input 930 is declined, change input 930 can be cleared for new input. If the change in change input 930 is accepted, the syntax of the change in change input 930 can be checked. Information regarding any error in the syntax can be displayed in syntax error notification output 915. If the syntax is acceptable, the rendition in instruction display 905 can be altered to reflect the change and the change can be conveyed to a server so that it can be implemented in activated instructions.

Various implementations of the systems and techniques described here can be realized in digital electronic circuitry, integrated circuitry, specially designed ASICs (application specific integrated circuits), computer hardware, firmware, software, and/or combinations thereof. These various implementations can include one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) may include machine instructions for a programmable processor, and can be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing environment that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the environment can be interconnected by any form or medium of digital data communication (e.g., a communication network). Examples of communication networks include a local area network (“LAN”), a wide area network (“WAN”), and the Internet.

A number of implementations have been described. Nevertheless, it will be understood that various modifications may be made. For example, the order of activities in processes 300, 800 can be changed and meaningful results can still be achieved. Some or all of the activities denoted as performed at a server can be performed at a client, and some or all of the activities denoted as performed at a client can be performed at a server. Accordingly, other implementations are within the scope of the following claims.

What is claimed is:

1. A method comprising:
receiving an identification of a debugger;
identifying a portion of a set of activated machine-readable instructions that is to be tested;
establishing a second version of the portion of the set of machine-readable instructions; and
activating the second version for the debugger while the portion of the set remains activated.

2. The method of claim 1, wherein establishing the second version comprises copying the portion of the set of machine-readable instructions.

3. The method of claim 2, wherein establishing the second version further comprises:
receiving a change to the portion of the set of machine-readable instructions; and
including the change in the second version.

4. The method of claim 1, wherein the portion of the set of machine-readable instructions comprises an independently functional module.

5. The method of claim 1, further comprising providing services to the debugger using the activated second version.

6. The method of claim 1, wherein the portion of the set of machine-readable instructions comprises a globally activated, independently functional module.

7. The method of claim 1, further comprising replacing the portion of the set of machine-readable instructions with the second version.

8. The method of claim 7, wherein replacing the portion of the set of machine-readable instructions comprises globally activating the second version in a distributed data processing system landscape.

9. A method comprising:
receiving an identification of a debugger;
identifying an activated business software module that is to be debugged, the business software module comprising an individually functional set of machine-readable instructions operable to integrate and manage operations of a business;
receiving a change to the instructions of the business software module;
establishing a second version of the business software module that includes the change; and
activating the second version for the debugger while the business software module remains activated.

10. The method of claim 9, wherein receiving the change comprises:
outputting the instructions of the business software module to the debugger;
checking syntax of the change to the instructions; and
notifying the debugger if the syntax is unacceptable.

11. An article comprising a machine-readable medium storing instructions operable to cause one or more machines to perform operations comprising:
outputting a set of activated machine-readable instructions to a user, the activated instructions being available to the runtime environment of a data processing system;
receiving a change to the activated machine-readable instructions from the user; and
implementing the change in the activated machine-readable instructions without deactivating the activated machine-readable instructions.

12. The article of claim 11, wherein the operations further comprise:
checking syntax of the change to the activated machine-readable instructions; and
notifying the user if the syntax is unacceptable.

13. The article of claim 11, wherein outputting the set of activated machine-readable instructions comprises displaying text of activated source code to the user.

14. The article of claim 11, wherein the activated machine-readable instructions comprise a locally activated set of activated machine-readable instructions.

15. The article of claim 11, wherein the activated machine-readable instructions comprise a business software module.

16. The article of claim 11, wherein implementing the change in the activated machine-readable instructions comprises providing services to a client in a distributed data processing landscape.

17. The article of claim 11, wherein implementing the change comprises providing services to the user in a distributed data processing system landscape.
